(19) United States
(12) Patent Application Publication
(10) Pub. No.: US 2025/0270428 A1
(43) Pub. Date: Aug. 28, 2025

(54) THERMOPLASTIC HOTMELT ADHESIVE COMPOSITION WITH FLAME RETARDANT

(71) Applicant: Henkel AG & Co. KGaA, Düsseldorf (DE)

(72) Inventors: Bettina Becker, Mettmann (DE); Liane Meuten, Monheim (DE); Dwight Heinrich, Aurora, IL (US); Mary S. Miller, Joliet, IL (US); Luca Mario Marchese, Casarile (IT); Stefano Cremonesi, Siziano - Pavia (IT)

(21) Appl. No.: 19/204,894

(22) Filed: May 12, 2025

Related U.S. Application Data
(63) Continuation of application No. PCT/EP2023/079738, filed on Oct. 25, 2023.
(60) Provisional application No. 63/424,983, filed on Nov. 14, 2022.

(51) Int. Cl. C09J 177/08; C08J 3/20; C08K 5/3492; C08K 5/5399; C09J 9/00

(52) U.S. Cl. CPC C09J 177/08; C08J 3/201; C08J 3/203; C08K 5/34924; C08K 5/5399; C09J 9/00; C08J 2377/08

(57) ABSTRACT

The present invention relates to thermoplastic hotmelt adhesive compositions comprising a flame-retardant mixture, a process for producing the compositions as well as their use in low-temperature pressure molding.

The present invention relates to thermoplastic hotmelt adhesive compositions comprising a flame-retardant mixture, a process for producing the compositions as well as their use in low-temperature pressure molding.

Thermoplastic hotmelt adhesives are widely used in various fields such as electric and electronic products and communication equipment. Certain applications require the thermoplastic hotmelt adhesives to have flame retardancy for protection against the heat and ignition of internal parts in devices and appliances. In order to impart said flame retardancy, a flame retardant is generally added. However, flame retardants are usually solids or compounds of high viscosity which negatively affect the viscosity of the hotmelt adhesive, rendering the hotmelt adhesive unsuitable for low-temperature pressure molding technology. Further, thermoplastic hotmelt adhesives are used for encapsulating electric and electronic components such as printed circuit boards (PCB), connectors and sensors. In particular phosphorous-based flame retardants are known for their critical corrosion behavior which might affect the sensitive encapsulated compound.

EP 1 104 766 describes cross-linked phenoxyphosphazene compounds as flame retardants and flame-retardant resin compositions comprising said flame retardant.

EP 1 975 217 refers to flame-resistant adhesive or sealing compositions containing 0.1 to 99 wt.-% of an adhesive or thermoplastic polymer and 0.1 to 99 wt.-% of a flame retardant comprising at least one dialkyl or diaryl phosphinic acid metal or organic base salt and/or alkylene or arylene-diphosphinic acid metal or organic base salts.

CN 10340320 discloses a halogen-free flame-retardant polyamide hotmelt adhesive comprising 100 parts dimer acid type polyamide hotmelt adhesive, 15 to 65 parts halogen-free flame retardant and 0.3 to 3 parts antioxidant.

In order to be applicable in the production of electric or electronic compounds, hotmelt adhesive compositions should obtain a flame retardancy classification of V-0 in flame retardancy test UL-94 (Testing for Flammability of Plastic Materials for Parts in Devices & Appliances) which is a standard test for evaluating flame retardancy. For obtaining a rating of V-0, flaming should not continue for more than a specified period, and no molten resin drips which ignite the cotton located below the test specimens, should occur. It was found that some standard thermoplastic hotmelt adhesive compositions may achieve a rating of V-0 but could not maintain said V-0 classification after aging and/or with different thicknesses. It is therefore an object of the present invention to provide a thermoplastic hotmelt adhesive composition which is able to meet the requirement of V-0 rating while at the same time having a low viscosity and good corrosion resistance in order to be applicable in low-temperature pressure molding technology.

It was surprisingly found that the object is solved by a thermoplastic hotmelt composition based on polyamide comprising a mixture of phosphorous-based flame retardant and halogen-free flame retardant.

Accordingly, a first object of the present invention is a thermoplastic hotmelt adhesive composition comprising:
a) at least one polyamide;
b) at least one phosphorous-based flame retardant in an amount of 0.1 to 5 wt.-%; and
c) at least one halogen-free flame retardant in an amount of 0.1 to 15 wt.-%,
   based on the total weight of the composition wherein the at least one phosphorous-based flame retardant is different from the at least one halogen-free flame retardant.

The hotmelt adhesive composition according to the invention was found to have an improved thermal stability which allowed for a V-0 rating even after aging and with different thicknesses.

In a preferred embodiment, the at least one halogen-free flame retardant is selected from the group consisting of melamine cyanurate, melamine polyphosphate, ammonium phosphate, pentaerythritol and zinc oxide. In particular, the at least one halogen-free flame retardant is melamine cyanurate.

Polyamide hotmelt adhesives are generally characterized by their good adhesion properties and high chemical resistance. In particular polyamides based on dimer fatty acids additionally show good basic flame-retardant properties. Therefore, in a preferred embodiment, the at least one polyamide is a polyamide based on dimer fatty acids.

Dimer or polymer fatty acids within the meaning of this invention are those fatty acids that can be obtained in a known manner by dimerization of from natural raw materials. These are produced from unsaturated long-chain fatty acids and then purified by distillation. As technical dimer fatty acid, depending on the degree of purity, less than 5% monobasic fatty acids are contained, substantially C₁₈ fatty acids such as linolenic acid or oleic acid, up to 98 wt. % C₃₆ dibasic fatty acids (dimer fatty acids in the narrower sense) and also small proportions of higher polybasic fatty acids (“trimer acids”). The relative ratios of the monomer, dimer and trimer fatty acids in the polymer fatty acid mixture depend on the nature of the starting compounds used and the polymerization, dimerization or oligomerization conditions and the degree of distillative separation. Dimer fatty acids purified by distillation contain up to 98 wt. % of dimer fatty acid. In another processing step, these dimer fatty acids can also be hydrogenated. These hydrogenated dimer fatty acids can also be used according to the invention.

In a preferred embodiment, the at least one polyamide is obtained from a reaction mixture comprising at least one dimer fatty acid and at least one dicarboxylic acid, preferable one selected from C₆ to C₂₄ dicarboxylic acids. Examples of these dicarboxylic acids are succinic acid, adipic acid, azelaic acid, sebacic acid, undecanedioic acid, dodecanedioic acid, glutaric acid, suberic acid or pimelic acid. Proportions of aromatic dicarboxylic acids, such as e.g. terephthalic acid, isophthalic acid or mixtures of the aforementioned dicarboxylic acids, can also be used in the reaction mixture. Preferably, however, longer-chain aliphatic dicarboxylic acids, for example from C₁₀ to C₁₈, are selected; in this case, water absorption by the resulting polyamide can be reduced.

The diamine component substantially consists of one or more aliphatic diamines, wherein the amino groups are at the ends of the carbon chains. The aliphatic diamines can contain 2 to 20 carbon atoms, with the aliphatic chain being linear or branched. Examples are ethylenediamine, diethylenetriamine, dipropylenetriamine, 1,4-diaminobutane, 1,3-pentanediamine, methylpentane diamine, hexamethylenediamine, trimethyl hexamethylenediamine, 2-(2-aminomethoxy)ethanol, 2-methyl pentamethylenediamine, C₁₁ neopentane diamine, diaminodipropylmethylamine or 1,12-diaminododecane. Particularly preferred primary alkylene diamines are C₂-C₁₂ diamines with an even number of carbon atoms.

The amino component can also contain cyclic diamines or heterocyclic diamines, such as e.g. 1,4-cyclohexanediamine, 4,4′-diaminodicyclohexylmethane, piperazine, cyclohexanebis (methylamine), isophorone diamine, dimethylpiperazine, dipiperidyl propane, norbornanediamine or m-xylylenediamine. A particular embodiment uses a mixture of alkylene diamines and cyclic diamines.

The thermoplastic hotmelt adhesive composition of the present invention comprises at least one phosphorous-based flame retardant. The at least one phosphorous-based flame retardant is preferably selected from the group consisting of cyclic phosphonates and cross-linked phenoxyphosphazene compounds. In an especially preferred embodiment, the at least one phosphorous-based flame retardant is a cross-linked phenoxyphosphazene compound comprising a cyclic phosphazene group and a straight or branched phosphazene chain crosslinked with at least one crosslinking group selected from the group consisting of phenylene group and bisphenylene group. Suitable cross-linked phenoxyphosphazene compounds are described in EP 1 104 766. In a preferred embodiment, the phosphorous-based flame retardant has a solubility in water at 25° C. of less than 0.05%, preferably less than 0.02%, in particular less than 0.01%. Surprisingly, employment of such a phosphorous-based flame retardant in the inventive composition resulted in improved corrosion and thermal stability properties.

In a preferred embodiment of the thermoplastic hotmelt adhesive composition of the present invention, the at least one polyamide is comprised in the composition in an amount of at least 80 wt.-%, preferably at least 85 wt.-%, based on the total weight of the composition, respectively.

The thermoplastic hotmelt adhesive composition is characterized by its low content of halogen-free flame retardant. In addition, it was surprisingly found that the amount of phosphorous-based flame retardant could also be kept at low amounts without affecting the flame retardancy of the composition. In a preferred embodiment, the amount of the at least one phosphorous-based flame retardant in the composition is therefore 0.2 to 2 wt.-%, based on the total weight of the composition, respectively.

In a further preferred embodiment, the amount of halogen-free flame retardant in the composition is 1.0 to 12 wt.-%, more preferably 5 to 9.5 wt.-%, based on the total weight of the composition, respectively.

In an especially preferred embodiment, the thermoplastic hotmelt adhesive composition comprises at least 80 wt.-%, preferably at least 85 wt.-% of a polyamide based on dimer fatty acid, preferably 0.2 to 2 wt.-% of a cross-linked phenoxyphosphazene compound and 1.0 to 12 wt.-%, more preferably 5 to 9.5 wt.-% of melamine cyanurate.

A low viscosity is one requirement of hotmelt adhesives to be suitable for low-temperature pressure molding technology. Therefore, in a preferred embodiment, the thermoplastic hotmelt adhesive composition of the present invention has a viscosity at 200 to 230° C. of equal or less than 10,000 mPas, preferably less than 5000 mPas, determined according to ASTM D3236.

The inventive thermoplastic hotmelt adhesive composition of the present invention is further characterized by a high thermal stability to ensure a V-0 classification even after aging. Accordingly, an embodiment of the thermoplastic hotmelt adhesive composition is preferred wherein the thermoplastic hotmelt adhesive composition is thermally stable at temperatures of up to 210° C. The thermal stability may be determined visually by comparing the color of the heated composition to standard color sheets.

The thermoplastic hotmelt adhesive composition of the present invention preferably has a corrosion resistance according to J-STD-004 A at 40° C. and 90% rel. humidity of equal or more than 10⁸ Ohm. The high corrosion resistance makes the inventive hotmelt adhesive composition especially suitable for the manufacturing of electric and electronic components.

A further object of the present invention is a process for the production of a thermoplastic hotmelt adhesive composition of the present invention, wherein the at least polyamide is melted and the at least one phosphorous-based flame retardant and the at least one halogen-free flame retardant are added under stirring.

The hotmelt adhesive composition of the present invention is especially designed for low-temperature pressure molding. Therefore, in a further aspect, the present invention relates to the use of a thermoplastic hotmelt adhesive composition according to the present invention in low-temperature pressure molding technology. Preferably, the composition is used for encapsulating electric and/or electronic components.

Another object of the present invention is a molded article obtained from a thermoplastic hotmelt adhesive composition of the present invention by low-temperature pressure molding.

The present invention will be explained in more detail with reference to the following examples which by no means are to be understood as limiting the scope or spirit of the present invention.

### EXAMPLES

### Composition 1

89.5 wt.-% of a polyamide based on a dimer fatty acid with a softening point of 155° C. was melted and 1.5 wt.-% of a mixture of a phosphorous-based flame retardant with a solubility in water at 25° C. of more than 0.05% and 9 wt.-% melamine cyanurate were added under stirring.

The obtained hotmelt adhesive composition was found to fulfill the V-0 classification of UL 94 V and had a viscosity at 210° C. of 2,500 mPas. However, the composition showed slight discoloration at a temperature of 190° C.

### Composition 2

90 wt.-% of a polyamide based on a dimer fatty acid with a softening point of 155° C. was melted and 1.0 wt.-% of a phosphorous-based flame retardant having a solubility in water at 25° C. of less than 0.01% and 9 wt.-% melamine cyanurate were added under stirring.

The obtained composition fulfilled the requirements of UL 94 V for V-0 classification before and after aging 168 h at 70° C. and had a viscosity at 210° C. of 4,500 mPas. In addition, the composition had a satisfactory corrosion resistance of 10^{8.6} Ohm and showed no corrosion on PCB after 168 h at 40° C. and 90% rh according to J-STD-004 A. No discoloration when heated to 190° C. and only slight discoloration at a temperature of 210° C. could be detected.

### Composition 3

90 wt.-% of a polyamide based on a dimer fatty acid with a softening point of 175° C. was melted and 1.0 wt.-% of a phosphorous-based flame retardant having a solubility in water at 25° C. of less than 0.01% and 9 wt.-% melamine cyanurate were added under stirring.

The obtained composition fulfilled the requirements of UL 94 V for V-0 classification and had a viscosity at 225° C. of 4,500 mPas. In addition, the composition had a satisfactory corrosion resistance of 10^{8.2} Ohm and showed no discoloration when heated to temperatures up to 210° C. No corrosion on PCB could be detected after aging of the composition at 40° C. and 90 rel. humidity for 168 h. No change in flame retardancy could be seen after aging for 168 h at 70° C.

1. A thermoplastic hotmelt adhesive composition comprising:
a) at least one polyamide;
b) at least one phosphorous-based flame retardant in an amount of 0.1 to 5 wt.-%; and
c) at least one halogen-free flame retardant in an amount of 0.1 to 15 wt.-%,
based on the total weight of the composition,
wherein the flame retardant is selected from the group consisting of cyclic phosphonates and cross-linked phenoxyphosphazene compounds, and
wherein the at least one phosphorous-based flame retardant is different from the at least one halogen-free flame retardant.

2. The thermoplastic hotmelt adhesive composition according to claim 1, characterized in that the at least one halogen-free flame retardant is selected from the group consisting of melamine cyanurate, melamine polyphosphate, ammonium phosphate, pentaerythritol and zinc oxide.

3. The thermoplastic hotmelt adhesive composition according to claim 1, characterized in that the at least one halogen-free flame retardant is melamine cyanurate.

4. The thermoplastic hotmelt adhesive composition according to claim 1, characterized in that the at least one polyamide is a polyamide based on dimer fatty acids.

5. The thermoplastic hotmelt adhesive composition according to claim 4, characterized in that the at least one polyamide is obtained from a reaction mixture comprising at least one dimer fatty acid and at least one dicarboxylic acid.

6. (canceled)

7. The thermoplastic hotmelt adhesive composition according to claim 1, characterized in that the at least one polyamide is comprised in the composition in an amount of at least 85 wt.-%, based on the total weight of the composition, respectively.

8. The thermoplastic hotmelt adhesive composition according to claim 1, characterized in that the amount of the at least one phosphorous-based flame retardant in the composition is 0.2 to 2 wt.-%, based on the total weight of the composition, respectively.

9. The thermoplastic hotmelt adhesive composition according to claim 1, characterized in that the amount of halogen-free flame retardant in the composition is 5 to 9.5 wt.-%, based on the total weight of the composition, respectively.

10. The thermoplastic hotmelt adhesive composition according to claim 1, characterized in that the composition has a viscosity at 200 to 230° C. of equal or less than 5000 mPas, determined according to ASTM D3236.

11. The thermoplastic hotmelt adhesive composition according to claim 1, characterized in that the composition is thermally stable at temperatures up to 210° C.

12. The thermoplastic hotmelt adhesive composition according to claim 1, characterized in that the composition has a corrosion resistance according to J-STD-004 A at 40° C. and 90% rel. humidity of equal or more than 10⁸ Ohm.

13. A process for the production of a thermoplastic hotmelt adhesive composition according to claim 1, wherein the at least polyamide is melted and the at least one phosphorous-based flame retardant and the at least one halogen-free flame retardant are added under stirring.

14. (canceled)

15. A molded article obtained from a thermoplastic hotmelt adhesive of claim 1.
